(19) United States
(12) Patent Application Publication
(10) Pub. No.: US 2026/0097775 A1
(43) Pub. Date: Apr. 9, 2026

(54) POWERTRAIN CONTROL SYSTEMS AND METHODS INCLUDING SENSORS THAT STORE POWERTRAIN FAULT CONDITION DATA

(71) Applicant: Cummins Inc., Columbus, IN (US)

(72) Inventor: Thomas C. Smith, JR., Oxford, MS (US)

(21) Appl. No.: 18/910,776

(22) Filed: Oct. 9, 2024

(51) Int. Cl. B60W 50/02; B60W 10/04; G07C 5/08

(52) U.S. Cl. CPC B60W 50/0205; G07C 5/085; B60W 10/04; B60W 2050/021

(57) ABSTRACT

A sensor is provided for use in a control system of a powertrain, such as for a vehicle or other application. The sensor provides outputs indicative of one or more operating parameters of the powertrain to a control unit of the control system. The control unit is configured to determine if a fault condition is present based at least in part on the outputs provided by the sensor. Fault condition data for fault conditions that are determined to be present at least in part on the sensor outputs are recorded on a memory of the sensor.

### TECHNICAL FIELD

The present disclosure generally relates to powertrain control systems and methods, and more particularly to powertrain control systems and methods that includes sensors that store powertrain fault condition data.

### BACKGROUND

Powertrains for vehicles, gensets, and other applications generate operating parameters that are detected by sensors and transmitted via signals to one or more electronic control units of the powertrain, such as an engine control unit and/or aftertreatment control unit. The data represented by these signals is evaluated in the control unit(s) to monitor powertrain performance and provide diagnostics that may indicate a fault condition of one or more components or subsystems of the powertrain. These fault conditions are typically identified via fault codes that are stored in the control unit.

When the powertrain is serviced to correct an issue in response to a fault code that is output by the control unit(s), the service center technician may replace one or more sensors whose output created the fault condition, or that were involved in identifying the fault condition, that caused the fault code to be generated. The fault code is then cleared from the control unit(s), and the sensors that were replaced are returned for a warranty claim, such as to the manufacturer or other warrantor. If the fault code information is not provided with the returned sensor(s), then the warrantor may not be able to diagnose the issue that caused the fault condition. This can lead to delays and increased costs in addressing sensor issues that create fault conditions and/or in determining liability for a warranty claim. Therefore, further improvements in this area are needed.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created and that the invention includes and protects such alterations, modifications, and further applications of the example embodiments as would occur to one skilled in the art.

### SUMMARY

Sensors are disclosed herein that are configured to store fault condition data for a powertrain. In one embodiment, a sensor is provided for use in a control system of a powertrain, such as for a vehicle or other application. The sensor is operable to provide outputs indicative of one or more operating parameters of the powertrain to a control unit of the control system. The control unit is configured to determine if a fault condition is present based at least in part on the outputs provided by the sensor. Fault condition data for fault conditions of the powertrain that are determined to be present based at least in part on the sensor outputs is stored on a memory of the sensor for subsequent retrieval and evaluation. Further embodiments, forms, objects, features, advantages, aspects, and benefits shall become apparent from the following description and drawings.

### BRIEF DESCRIPTION OF THE DRAWINGS

The description herein makes reference to the accompanying drawings wherein like reference numerals refer to like parts throughout the several views, and wherein:

FIG. 1 is a schematic block diagram of a system including a powertrain and a control system according to an embodiment of the present disclosure;

FIG. 2 is a schematic block diagram of the control system of FIG. 1 according and embodiment of the present disclosure; and

FIG. 3 is a flow diagram of a procedure or method according to an embodiment of the present disclosure.

### DETAILED DESCRIPTION

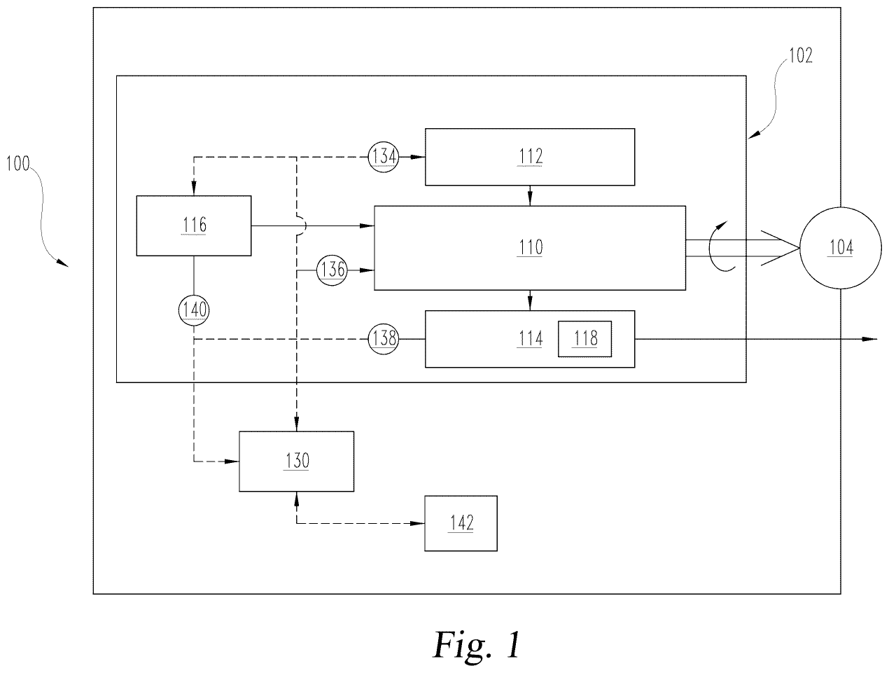

With reference to FIG. 1, there is illustrated an example system 100 including a powertrain 102 and at least a portion of one or more loads 104. System 100 may be provided in a number of forms including, for example, in the form of a vehicle or vehicle powertrain system (e.g., an on-highway vehicle or vehicle powertrain system or an off-highway vehicle or vehicle powertrain system), a work machine or work machine powertrain system, a genset or genset powertrain system, or a hydraulic fracturing rig or hydraulic fracturing rig powertrain system, to name several non-limiting examples. In shall be appreciated that system 100 may include a number of other components not specifically shown or discussed herein as will occur to one of skill in the art with the benefit and insight of the present disclosure.

In the illustrated example, powertrain 102 is configured and provided with a prime mover such as an internal combustion engine 110 including an intake air handling system 112, an exhaust system 114, a fueling system 116, and an electronic control system (ECS) 130. It shall be appreciated that powertrain 102 may include a number of other components as will occur to one of skill in the art with the benefit and insight of the present disclosure. In other example embodiments, powertrain 102 may be configured and provided with any suitable type of prime mover and associated air handling and/or fuel/power systems, such as, for example, a hybrid combustion engine-electric prime mover, a battery electric prime mover, a fuel cell prime mover, or another type of prime mover.

Intake air handling system 112 may include one or more air handling conduits, air filters, compressors (such as a compressor of a turbocharger or supercharger), coolers (such as charger air coolers, intercoolers, and/or aftercoolers which may be, for example, of an air-to-air type or an air-to-liquid type), as well as other components. Intake air handling system 112 may include one or more intake sensors 134, such as temperature sensors, pressure sensors, mass flow sensors, and other types of sensors.

An internal combustion engine 110 type of prime mover may be provided in a number of forms and typically includes a block including a plurality of cylinders and a head coupled with the block. The head typically includes intake ports, intake valves configured to selectively open and close the intake ports, exhaust ports, exhaust valves configured to selectively open and close the exhaust ports, injector bores, fuel injectors disposed in the injector bores, spark plug bores, and spark plugs disposed in the spark plug bores. A plurality of pistons may be provided in respective ones of the plurality of cylinders. A crankshaft may be coupled with the plurality of pistons and configured to translate reciprocating motion of the plurality of pistons to provide torque for driving loads 104 which may include internal loads of internal combustion engine 110 (such oil pumps, valvetrains, fuel pumps and other loads of internal combustion engine 110, and accessory loads of internal combustion engine 110).

It shall be appreciated that internal combustion engine 110 may include one or more engine sensors 136, such as speed sensors, combustion sensors, temperature sensors, flow sensors, pressure sensors, oxygen or lambda sensors. Internal combustion engine 110 may also include a number of other components as will occur to one of skill in the art with the benefit and insight of the present disclosure.

Exhaust system 114 may include one or more aftertreatment components 118, such as oxidation catalysts, particular filters, selective catalytic reduction (SCR) catalysts, and/or other catalysts and aftertreatment components. Exhaust system 114 may also include exhaust handling conduits, turbines (such as a turbine of a turbocharger), and other components. Exhaust system 114 may also include one or more exhaust sensors 138, such as temperature sensors, pressure sensors, oxygen or lambda sensors, mass flow sensors, and other types of sensors.

Fueling system 116 may be configured and provided as a high-pressure common-rail fuel injection system including a plurality of fuel injectors in fluid communication with a common fuel rail, which supplies fuel at relatively high pressure to the plurality of fuel injectors. Fuel may be supplied to the common fuel rail by a high-pressure pump which, in turn, may be fed by a relatively low-pressure fuel circuit including a booster pump, which may be immersed in a tank containing a reservoir of fuel. However, any suitable fuel system capable of providing liquid fuel, gaseous fuel, and/or electric energy is contemplated. Fuel system 116 may also include one or more fuel sensors 140, such as temperature sensors, pressure sensors, flow sensors, constituent sensors, and other types of sensors.

ECS 130 preferably includes one or more programmable microcontrollers of a solid-state, integrated circuit type, and one or more non-transitory memory media configured to store instructions executable by the one or more microcontrollers. For purposes of the present application the term microcontroller shall be understood to also encompass microprocessors and other types of integrated circuit processors. ECS 130 is in operative communication with and may be adapted and configured to control operation of and/or receive inputs from sensors or controllers of internal combustion engine 110, intake air handling system 112, exhaust system 114, and fueling system 116.

In an embodiment, ECS 130 is in operative communication with and may be adapted and configured to control operation of and/or receive inputs from one or more sensors of system 100 which may include, for example, any one or combination of intake sensors 134, engine sensors 136, exhaust sensors 138, fuel sensors 140, or other types of system sensors 142 such as throttle position sensors or accelerator position sensors. It shall be appreciated that FIG. 1 depicts control relationships between the foregoing components conceptually using dashed arrows and that various communications hardware and protocols may be utilized to implement, such as one or more controller area networks (CAN) or other communications components.

ECS 130 can be implemented in any of a number of ways that combine or distribute the control function across one or more control units in various manners. The ECS 130 may execute operating logic that defines various control, management, and/or regulation functions. This operating logic may be in the form of dedicated hardware, such as a hardwired state machine, analog calculating machine, programming instructions, and/or a different form as would occur to those skilled in the art. The ECS 130 may be provided as a single component or a collection of operatively coupled components; and may be comprised of digital circuitry, analog circuitry, or a hybrid combination of both of these types. When of a multi-component form, the ECS 130 may have one or more components remotely located relative to the others in a distributed arrangement. The ECS 130 can include multiple processing units arranged to operate independently, in a pipeline processing arrangement, in a parallel processing arrangement, or the like. It shall be further appreciated that the ECS 130 and/or any of its constituent components may include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, Analog to Digital (A/D) converters, Digital to Analog (D/A) converters, and/or different circuitry or components as would occur to those skilled in the art to perform the desired communications.

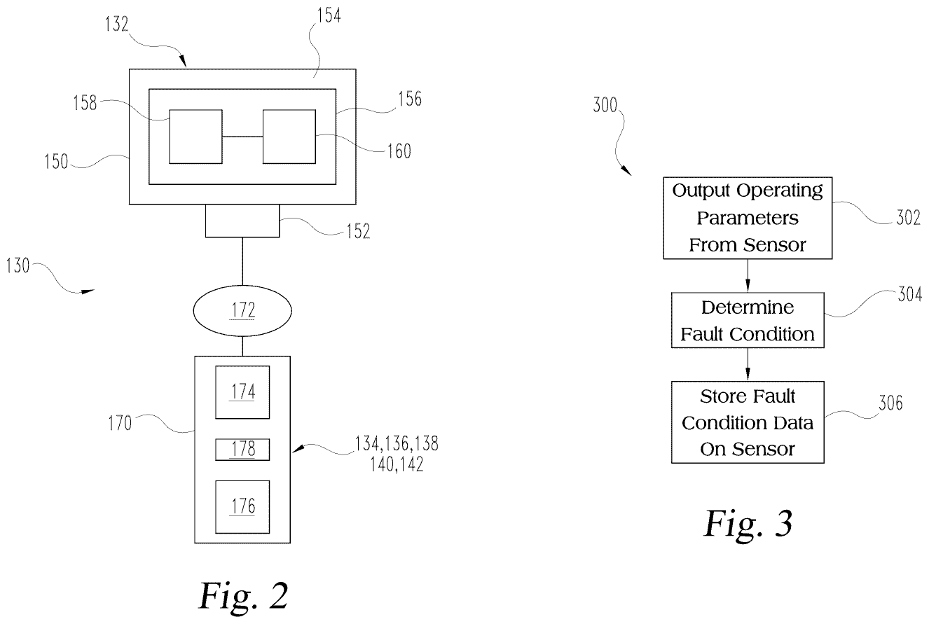

With reference to FIG. 2 there is illustrated an example implementation of ECS 130. In the illustrated example, ECS 130 comprises at least one electronic control unit (ECU) 132 for controlling and/or monitoring an operation of one or more parts of powertrain 102. The ECU 132 comprises a base 150 and an interface 152. The base 150 encloses an interior 154 containing a plurality of electronic control components, including a printed circuit board 156 with a processor 158 and a memory 160 that stores instructions executable by processor 158. In an embodiment, the instructions stored on memory 160 are executable by processor 158 to determine a fault condition associated with powertrain 102 based on outputs provided to ECU 132 through interface 152 from sensors 134, 136, 138, 140, and/or 142.

In an embodiment, ECU 132 is a prime mover ECU or engine ECU that controls and/or monitors operation of a prime mover or prime mover system, such as internal combustion engine 110, intake air handling system 112, and/or exhaust system 114. In an embodiment, ECU 132 is alternatively or additionally an aftertreatment system ECU that controls and/or monitors operation of an aftertreatment system or aftertreatment component 118 in exhaust system 114. In an embodiment, ECU 132 is alternatively or additionally a fuel system ECU that controls and/or monitors operation of fueling system 116.

One or more of sensors 134, 136, 138, 140, 142 includes a housing 170 that is connected to powertrain 102 and to at least one ECU 132 via any suitable connection, such as by a wiring harness and/or a wireless connection. Each of the sensors 134, 136, 138, 140, 142 is operable to provide outputs 172 from its corresponding sensing element(s) 174 that are connected to and/or mounted in housing 170. Sensing element(s) 174 provide outputs 172 that are indicative of at least one of the one or more operating parameters of powertrain 102 to which the sensor 134, 136, 138, 140, 142 is connected.

Each of the sensors 134, 136, 138, 140, 142 includes a separate memory 176 and processor 178 located within the housing 170 of the corresponding sensor 134, 136, 138, 140, 142. The memory 176 is writable or re-writable to receive and record fault condition data that is stored on the memory 176 in response to instructions stored on processor 178. The stored fault condition data on memory 176 is associated with a fault condition determination by ECU 132 that is based at least in part on the outputs 172 provided by that particular sensor 134, 136, 138, 140, 142. The fault condition data can be communicated from ECU 132 and/or from a service diagnostic tool used by a service technician to memory 176. In an embodiment, communications of fault condition data are made with Controller Area Network (CAN) messages using the Controller Area Network (CAN) bus protocol to transmit data between ECU 132 and/or the diagnostic tool and one or more of sensor(s) 134, 136, 138, 140, 142. In a specific embodiment, the CAN messages are SAE J1939 messages.

For example, for an exhaust sensor 138 that is a NOx type sensor, ECU 132 can determine a fault condition if NOx levels that are output from exhaust sensor 138 exceed a threshold amount during a low or no NOx producing operating state of powertrain 102. The fault code is generated by processor 158 and stored on memory 160 of ECU 132 along with other fault condition data. The fault code and other information or data associated with the fault condition is then recorded in memory 176 of the exhaust sensor 138 that provided the NOx outputs upon which the fault code was determined.

In an embodiment, the fault condition data stored on the memory 60 of sensor 134, 136, 138, 140, 142 includes a fault code or faults codes of the fault condition that triggered the fault code in ECU 132 based on outputs from the corresponding sensor 134, 136, 138, 140, 142. The fault condition data stored on memory 60 may also include a number of times the fault code or codes occurred, a time stamp for each fault code, and/or a state of the powertrain 102 at the time of each fault code. Other fault condition data may also be included and is not precluded.

The state of powertrain 102 during the fault condition can include any suitable indication of one or more operating parameters or other information that indicates the powertrain state. For example, the state of powertrain 102 may include one or more of a speed of engine 110 or other prime mover or component of powertrain 102, a load on engine 110 or other prime mover, a temperature of any one or more components of powertrain 102, a fuel rate or amount of fuel provided to engine 110 or other prime mover, a flow rate such for intake air or exhaust, a constituent amount in the exhaust or combustion products, an accelerator pedal position, a brake pedal position, a gear state, and a charge on an energy storage device, just to name a few examples.

Referring to FIG. 3, a method 300 for operating powertrain 102 is provided. Method 300 includes an operation 302 to output one or more operating parameters associated with the powertrain 102 from sensor(s) 134, 136, 138, 140, 142 operably connected to powertrain 102 and to ECU 132. Each of the one or more sensor(s) 134, 136, 138, 140, 142 is operably connected to at least one ECU 132 that is configured to receive the sensor outputs from at least one of the sensors 134, 136, 138 140, 142 and evaluate the sensor outputs for diagnostics of one or more components and/or conditions of powertrain 102.

Method 300 includes an operation 304 to determine a fault condition of powertrain based 102 at least in part on the one or more operating parameters output by one or more of the sensor(s) 134, 136, 138, 140, 142. For example, ECU 132 may include logic programmed in memory 160 that is executable by processor 158 to determine a fault condition based on the sensor outputs from sensor(s) 134, 136, 138, 140, 142 and assign a fault code to the fault condition. In an embodiment, the fault code identifies the type of malfunction of the powertrain 102 and a location of the malfunction within powertrain 102. ECU 132 may also record data pertaining to the conditions of powertrain 102 during operation of powertrain 102 and/or during occurrence of the malfunction, such as a state of powertrain 102, time stamps for fault detections and/or fault code generations, a log of previously determined fault codes and associated fault condition data, and other relevant data.

Method 300 further includes an operation 306 to store fault condition data associated with the fault condition on memory 176 of the particular sensor or sensors 134, 136, 138, 140, 142 that provided outputs upon which the fault condition determination is based. For example, ECU 132 can write the fault code or fault codes and associated fault condition data onto memory 176 so that the fault condition data is accessible via the sensor(s) 134, 136, 138, 140, 142 without having to access the ECU 132. The fault condition data is also accessible from the memory 176 of the relevant sensor(s) 134, 136, 138, 140, 142 even if the fault condition data is subsequently cleared from ECU 132.

In an embodiment of method 300, one or more operating parameters of powertrain 102 are output from sensor(s) 134, 136, 138, 140, 142 to ECU 132 while one or more ECUs 132 control and/or monitor operation of powertrain 102. The fault condition and the fault condition data associated with the fault condition are determined by and stored in memory 160 of ECU(s) 132, and the ECU(s) 132 are operable to automatically write the fault condition data from the memory 160 of each ECU 132 onto memory 176 of the sensor(s) 134, 136, 138, 140, 142 that provided outputs upon which the fault condition determination was based.

In an embodiment of method 300, the fault condition data that is stored in memory 176 includes at least one fault code that indicates the fault condition or fault conditions of the powertrain 102 on the memory of the sensor(s) 134, 136, 138, 140, 142. In an embodiment of method 300, the fault condition data that is stored on memory 176 of sensor(s) 134, 136, 138, 140, 142 includes a plurality of fault codes that are each associated with a different occurrence of the fault condition and a time stamp for an occurrence of each of the plurality of fault codes. In an embodiment of method 300, the fault condition data that is stored in memory 176 of sensor(s) 134, 136, 138, 140, 142 includes a state of the powertrain 102 during the occurrence of the fault condition.

In an embodiment, method 300 may further include evaluating the sensor(s) 134, 136, 138, 140, 142 after a service event. For example, a service technician may review the fault codes in ECU 132 to determine a course of action for repair, make the required repairs, and then clear the fault condition data from ECU 132. However, since the fault condition data is stored in memory 176 of the relevant sensor(s) 134, 136, 138, 140, 142, any repaired or replaced sensor 134, 136, 138, 140, 142 can still be evaluated to retrieve the fault condition data related to the fault code.

In an embodiment, method 300 includes an operation to disconnect the sensor(s) 134, 136, 138, 140, 142 from powertrain 102, such as might occur during a servicing event for powertrain 102 to repair or replace the sensor to address one or more fault codes. Method 300 may further include operations to retrieve the fault condition data from the disconnected sensor(s) 134, 136, 138, 140, 142 and diagnose a condition of sensor(s) 134, 136, 138, 140, 142 from the downloaded fault condition data. The retrieval of the fault condition data can be performed, for example, by a manufacturer or other warrantor of removed the sensor(s) 134, 136, 138, 140, 142 to assist in evaluating the sensor condition that resulted in the fault code. This evaluation can be used to determine warranty liability, data for repairing or refurbishing the sensor, and/or for design improvements for sensor(s) 134, 136, 138, 140, 142.

In an embodiment, method 300 includes an operation to output a plurality of operating parameters associated with powertrain 102 from respective ones of the sensors 134, 136, 138, 140, 142 while sensors 134, 136, 138, 140, 142 are operably connected to powertrain 102. Method 300 also includes an operation to determine fault conditions for powertrain 102 based on the plurality of operating parameters output by the plurality of sensors 134, 136, 138, 140, 142. Method 300 may further include an operation to store the fault condition data for each of the fault conditions from ECU(s) 132 in the memory 176 of only the ones of the plurality of sensors 134, 136, 138, 140, 142 whose operating parameter output was used in determining the fault condition. In this way, the memory 176 of each of the sensors 134, 136, 138, 140, 142 is only utilized for recording fault condition data associated with that particular sensor 134, 136, 138, 140, 142.

In an embodiment, an apparatus is provided that includes a sensor 134, 136, 138, 140, 142 connectable to powertrain 102 and to at least one ECU 132. The sensor 134, 136, 138, 140, 142 is operable to provide outputs indicative of one or more operating parameters of powertrain 102. The sensor 134, 136, 138, 140, 142 includes memory 176 having fault condition data stored thereon for fault conditions associated with powertrain 102 that are based at least in part on the outputs provided by the sensor 134, 136, 138, 140, 142. The fault condition data can be written onto the sensor memory from the ECU 132 and/or from a diagnostic tool such as may be used by a service technician.

Various aspects of the present disclosure are contemplated. According to one aspect, a control system is provided for a powertrain. The control system includes at least one control unit for controlling operation of the powertrain a sensor connected to the powertrain and to the at least one control unit. The at least one control unit includes a processor and a memory. The processor is configured to execute instructions stored on the memory to determine a fault condition of the powertrain based on one or more operating parameters of the powertrain. The sensor is operable to provide outputs indicative of at least one of the one or more operating parameters. The sensor includes a memory having fault condition data stored thereon for fault conditions that are based at least in part on the outputs provided by the sensor.

In an embodiment, the memory of the sensor is writable. In an embodiment, the memory of the sensor is re-writable.

In an embodiment, the at least one control unit is a prime mover control unit for a prime mover. In an embodiment, the prime mover provides power to propel a vehicle.

In an embodiment, the at least one control unit is an aftertreatment control unit for an aftertreatment system that receives exhaust produced by a prime mover.

In an embodiment, the fault condition data stored on the memory of the sensor includes a fault code. In an embodiment, the fault condition data includes a number of time the fault code occurred. In an embodiment, the fault condition data includes a time stamp for each fault code. In an embodiment, the fault condition data includes a state of the powertrain at the time of each fault code.

In an embodiment, the state of the powertrain in the fault condition data includes one or more of a speed, load, temperature, fuel rate or amount, accelerator pedal position, brake pedal position, and gear state.

According to another aspect of the present disclosure, a method for operating a powertrain includes outputting one or more operating parameters associated with the powertrain from a sensor operably connected to the powertrain; determining a fault condition of the powertrain based at least in part on the one or more operating parameters output by the sensor; and storing fault condition data associated with the fault condition on a memory of the sensor.

In an embodiment, storing the fault condition data includes storing at least one fault code that indicates the fault condition on the memory of the sensor.

In an embodiment, storing the fault condition data includes storing on the memory of the sensor a plurality of fault codes that are each associated with a different occurrence of the fault condition and a time stamp for an occurrence of each of the plurality of fault codes.

In an embodiment, storing the fault condition data includes storing a state of the powertrain during an occurrence of the fault condition.

In an embodiment, the method includes disconnecting the sensor from the powertrain; downloading the fault condition data from the sensor; and diagnosing a condition of the sensor from the downloaded fault condition data.

In an embodiment, the method includes outputting the one or more operating parameters from the sensor to a control unit that controls operation of the powertrain; determining the fault condition and the fault condition data associated with the fault condition in the control unit; and writing the fault condition data from the control unit to the sensor.

In an embodiment, the control unit is one of an engine control unit and an aftertreatment control unit.

In an embodiment, outputting the one or more operating parameters includes outputting a plurality of operating parameters associated with the powertrain from respective ones of a plurality of sensors operably connected to the powertrain.

Determining the fault condition of the powertrain includes determining fault conditions based on the plurality of operating parameters output by the plurality of sensors. Storing the fault condition data includes storing the fault condition data for each of the fault conditions in the memory of only the ones of the plurality of sensors whose operating parameter output was used in determining the fault condition.

According to another aspect of the present disclosure, an apparatus includes a sensor connectable to a powertrain and to at least one control unit. The sensor is operable to provide outputs indicative of one or more operating parameters of the powertrain. The sensor includes a memory having fault condition data stored thereon for fault conditions associated with the powertrain that are based at least in part on the outputs provided by the sensor.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A control system for a powertrain, the control system comprising:
at least one control unit for controlling operation of the powertrain, the at least one control unit including a processor and a memory, the processor being configured to execute instructions stored on the memory to determine a fault condition of the powertrain based on one or more operating parameters of the powertrain; and
a sensor connected to the powertrain and to the at least one control unit, the sensor being operable to provide outputs indicative of at least one of the one or more operating parameters, the sensor including a memory having fault condition data stored thereon for fault conditions that are based at least in part on the outputs provided by the sensor.

2. The control system of claim 1, wherein the memory of the sensor is writable.

3. The control system of claim 1, wherein the memory of the sensor is re-writable.

4. The control system of claim 1, wherein the at least one control unit is a prime mover control unit for a prime mover.

5. The control system of claim 4, wherein the prime mover provides power to propel a vehicle.

6. The control system of claim 1, wherein the at least one control unit is an aftertreatment control unit for an aftertreatment system that receives exhaust produced by a prime mover.

7. The control system of claim 1, wherein the fault condition data stored on the memory of the sensor includes a fault code.

8. The control system of claim 7, wherein the fault condition data includes a number of time the fault code occurred.

9. The control system of claim 8, wherein the fault condition data includes a time stamp for each fault code.

10. The control system of claim 9, wherein the fault condition data includes a state of the powertrain at the time of each fault code.

11. The control system of claim 10, wherein the state of the powertrain includes one or more of a speed, load, temperature, fuel rate or amount, accelerator pedal position, brake pedal position, and gear state.

12. A method for operating a powertrain, the method including:
outputting one or more operating parameters associated with the powertrain from a sensor operably connected to the powertrain;
determining a fault condition of the powertrain based at least in part on the one or more operating parameters output by the sensor; and
storing fault condition data associated with the fault condition on a memory of the sensor.

13. The method of claim 12, wherein storing the fault condition data includes storing at least one fault code that indicates the fault condition on the memory of the sensor.

14. The method of claim 12, wherein storing the fault condition data includes storing on the memory of the sensor a plurality of fault codes that are each associated with a different occurrence of the fault condition and a time stamp for an occurrence of each of the plurality of fault codes.

15. The method of claim 12, wherein storing the fault condition data includes storing a state of the powertrain during an occurrence of the fault condition.

16. The method of claim 12, further comprising:
disconnecting the sensor from the powertrain;
downloading the fault condition data from the sensor; and
diagnosing a condition of the sensor from the downloaded fault condition data.

17. The method of claim 12, further comprising:
outputting the one or more operating parameters from the sensor to a control unit that controls operation of the powertrain;
determining the fault condition and the fault condition data associated with the fault condition in the control unit; and
writing the fault condition data from the control unit to the sensor.

18. The method of claim 17, wherein the control unit is one of an engine control unit and an aftertreatment control unit.

19. The method of claim 12, wherein:
outputting the one or more operating parameters includes outputting a plurality of operating parameters associated with the powertrain from respective ones of a plurality of sensors operably connected to the powertrain;
determining the fault condition of the powertrain includes determining fault conditions based on the plurality of operating parameters output by the plurality of sensors; and
storing the fault condition data includes storing the fault condition data for each of the fault conditions in the memory of only the ones of the plurality of sensors whose operating parameter output was used in determining the fault condition.

20. An apparatus, comprising:
a sensor connectable to a powertrain and to at least one control unit, the sensor being operable to provide outputs indicative of one or more operating parameters of the powertrain, the sensor including a memory having fault condition data stored thereon for fault conditions associated with the powertrain that are based at least in part on the outputs provided by the sensor.
